(19) United States
(12) Patent Application Publication
(10) Pub. No.: US 2012/0257417 A1
(43) Pub. Date: Oct. 11, 2012

(54) DISPLAY APPARATUS

(75) Inventors: Kuo-Chih LEE, Hsin-Chu (TW); Wei-Yu Lin, Hsin-Chu (TW); Bo-Jie Su, Hsin-Chu (TW)

(73) Assignee: AU OPTRONICS CORP., Hsin-Chu (TW)

(21) Appl. No.: 13/417,467

(22) Filed: Mar. 12, 2012

(30) Foreign Application Priority Data
Apr. 10, 2011 (TW) 100135925

(51) Int. Cl. F21V 8/00; F21V 7/00

(52) U.S. Cl. 362/622; 362/624; 362/627

(57) ABSTRACT

A display apparatus includes a display panel, a light guide plate, a frame and an optical film disposed between the display panel and the light guide plate. The display panel is defined to have a display area and a non-display area adjacent to the display area. The frame surrounds the light guide plate, the optical film and the display panel. The frame includes a sidewall and a support structure extending from an inner surface of the sidewall to above the light guide plate. The support structure includes a light shielding part, a first support part configured to support the optical film. The light shielding part is connected to the first support part. A light-pervious area is formed between the light shielding part and the optical film. The first support part is under cover of the non-display area.

### TECHNICAL FIELD

The disclosure relates to a display apparatus, and more particularly to a display apparatus employing a non-self-luminous display panel.

### BACKGROUND

With the advances in display technology, the flat panel display apparatus has been widely used in our daily life. Today, the display apparatus are getting smaller, lighter and having a narrow border in response to consumer's demand.

FIG. 1 is a schematic partial cross-sectional view of a conventional liquid crystal display (LCD) apparatus. As shown in FIG. 1, the conventional liquid crystal display apparatus 100 includes a liquid crystal display panel 110, a light guide plate 120, a plurality of optical films 130, a frame 140 and a light source 150. The liquid crystal display panel 110 is defined to have a display area 114 and a non-display area 112. The light guide plate 120 has a light incident surface 122 and a light emitting surface 124. The light emitting surface 124 is adjacent to the light incident surface 122 and the light source 150 is disposed next to the light incident surface 122. The optical films 130 are sequentially disposed above the light emitting surface 124, and the liquid crystal display panel 110 is disposed above the optical films 130. The frame 140 has two supporting parts 142, 144 for supporting the optical films 130 and the liquid crystal display panel 110, respectively.

The light provided by the light source 150 first enters into the light guide plate 120 through the light incident surface 122 thereof and then enters into the optical films 130 from the light guide plate 120. However, because the light in an area A1 of the light guide plate 120 near the light incident surface 122 may not be fully mixed, poor light uniformity may occur once the non-fully mixed light enters into the optical films 130. Conventionally, the poor light uniformity can be avoided by the arrangement of the supporting part 142; that is, through disposing the supporting part 142 above the area A1 which may cause the poor light uniformity, the non-fully mixed light is blocked to prevent the non-fully mixed light from entering into the optical films 130. And thus, the liquid crystal display apparatus 100 can have a qualified display quality. However, to have a narrow boarder feature in the display apparatus 100, the width D1 of the frame 140 is getting smaller and thus a portion of the area A1 may be under cover of the display area 114, so the supporting part 142 also needs to extend correspondingly.

However, the supporting part 142 extending into under the display area 114 may block a portion of light and thereby resulting in the display area 114 having poor brightness in an edge area thereof. So, if a user watches the display apparatus 100 and has a viewing direction V1 perpendicular to the display panel 110, the user may see a dark region A2 occurred in the edge area of the display area 114. Similarly, if a user watches the display apparatus 100 and has a viewing direction V2 having an included angle relative to the display panel 110, the user may see a dark region A3 occurred in the edge area of the display area 114. In addition, even the supporting part 142 does not extend into under the display area 114, the user may still see a dark region occurred in the edge area of the display area 114 if the user has the viewing direction V2.

### SUMMARY OF EMBODIMENTS

Therefore, the present disclosure provides a display apparatus to avoid the dark region occurred in a display area thereof.

A display apparatus in accordance with an embodiment of the present disclosure includes a display panel, a light guide plate, an optical film and a frame. The display panel is defined to have a display area and a non-display area adjacent to the display area. The optical film is disposed between the display panel and the light guide plate. The frame surrounds the light guide plate, the optical film and the display panel. The frame includes a sidewall and a support structure. The support structure extends from an inner surface of the sidewall to above the light guide plate. The support structure includes a light shielding part, a first support part configured to support the optical film. The light shielding part is connected to the first support part, a light-pervious area is formed between the light shielding part and the optical film, and the first support part is under cover of the non-display area.

In the display apparatus according to the present disclosure, because the light-pervious area is formed between the light shielding part and the optical film(s) and the light can enter into the specific area of the optical film corresponding to the light shielding part through the light-pervious area. Thus, the display apparatus of the present disclosure can have enhanced brightness in the edge area of the display area thereof, and accordingly the display apparatus of the present disclosure can have a narrow boarder but without resulting in dark regions in the edge area of the display area thereof.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic partial cross-sectional view of a conventional liquid crystal display apparatus;

FIG. 2 is a schematic partial cross-sectional view of a display apparatus in accordance with an embodiment of the present disclosure;

FIG. 3 is a schematic partial cross-sectional view of a display apparatus in accordance with another embodiment of the present disclosure;

FIG. 4 is a schematic partial cross-sectional view of a display apparatus in accordance with another embodiment of the present disclosure; and

FIG. 5 is a schematic partial cross-sectional view of a display apparatus in accordance with another embodiment of the present disclosure.

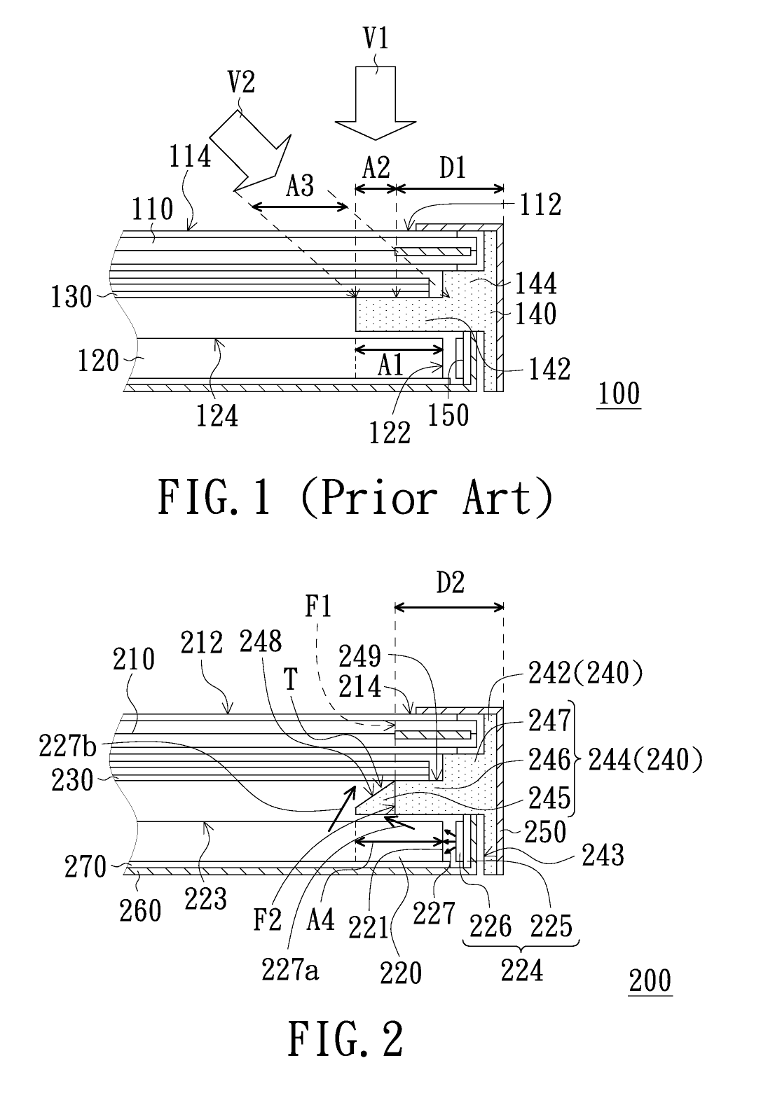

### DETAILED DESCRIPTION OF EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

FIG. 2 is a schematic partial cross-sectional view of a display apparatus in accordance with an embodiment of the present disclosure. As shown in FIG. 2, the display apparatus 200 includes a display panel 210, a light guide plate 220, an optical film 230 and a frame 240. The display panel 210 is defined to have a display area 212 and a non-display area 214 adjacent to the display area 212. The optical film 230 is disposed between the display panel 210 and the light guide plate 220. The frame 240 is configured to surround the light guide plate 220, the optical film 230 and the display panel 210.

In the present embodiment, the display panel 210 is a non-self-luminous display panel such as a liquid crystal display panel. The light guide plate 220 has a light incident surface 221 and a light emitting surface 223; wherein the light emitting surface 223 is adjacent to the light incident surface 221 and is opposite to the optical film 230. The display device 200 may further include a light emitting assembly 224 disposed next to the light incident surface 221 to provide light 227 to the light guide plate 220 through the light incident surface 221. The light emitting assembly 224 may include a circuit board 225 and at least one point light source 226 disposed on the circuit board 225; wherein the point light source 226 may, without limitation, be a light emitting diode (LED) or other types of semiconductor light sources. In addition, the number of the optical film 230 can be one or more than one, and the display apparatus 200 shown in FIG. 2 is exemplified by including more than one optical film 230. Moreover, the optical film 230 may be a prism sheet, a diffusing sheet or other types of films capable of homogenizing light. The display apparatus 200 may further include a front frame 250 and a back bezel 260 to cooperatively wrap the display panel 210, the light guide plate 220, the optical films 230 and the frame 240. A reflective film 270 may be disposed between the light guide plate 220 and the back bezel 260.

The frame 240 has a sidewall 242 and a support structure 244. The support structure 244, extending from an inner surface 243 of the sidewall 242 to above the light guide plate 220, includes a light shielding part 245 and a first support part 246 configured to support the optical films 230. The light shielding part 245 is connected to the first support part 246, the first support 246 is under cover of the non-display area 214, and at least a portion of the light shielding part 245 is under cover of the display area 212. In the present embodiment, a boundary F1 between the display area 212 and the non-display area 214, for example, exactly corresponds to a boundary F2 between the first support part 246 and the light shielding part 245, so the entire light shielding part 245 is under cover of the display area 212. In other embodiments, the boundary F2 may be under cover of the non-display area 214; that is, the boundary F2 is located right under the non-display area 214, and accordingly a portion of the light shielding part 245 is under cover of the display area 212. In addition, it is to be noted that the support structure 244 may further include a second support part 247 configured to support the display panel 210; and the support structure 244, due to the first support part 246 and the second support part 247, accordingly has a stair-like structure.

In the present embodiment as shown in FIG. 2, the light shielding part 245 is, for example, made of an opaque material; and the first support part 246, the second support part 247 and the sidewall 242 together as a whole is, for example, made of an opaque material. The light shielding part 245, the first support part 246, the second support part 247 and the sidewall 242 may be integrated into a one-piece structure. In addition, a gap is formed between the optical film 230 and a first surface 248 of the light shielding part 245 facing to the optical film 230, and thus an air layer is formed between the first surface 248 and the optical film 230. The air layer is referred to as a light-pervious area T. In addition, the first support part 246 has a supporting plane 249 configured to support the optical film 230. The first surface 248 of the light shielding part 245 is an inclined plane relative to the supporting plane 249; however, the structure of the first surface 248 is not limited as such, and the first surface 248 may, for example, have other structure such as a curved plane.

As described above, due to having a smaller edge width of D2, the display apparatus 200 in the present embodiment can have a narrow boarder. However, reducing the edge width of D2 may result in that the non-fully mixed light 227a enters into the display area 212 from an area A4 of the light guide plate 220 near to the light incident surface 221. Therefore, in the present embodiment the light shielding part 245 is used to block and prevent the light 227a from entering into the optical film 230 so as to improve the displaying quality of the display apparatus 200. In addition, because the light-pervious area T are formed between the light shielding part 245 and the optical film 230 and the fully mixed light 227b can enter into a specific area of the optical film 230 corresponding to the light shielding part 245 through the light-pervious area T, accordingly the brightness in the edge area of the display area 212 is enhanced and thus the dark region which likely occurs in the edge area of the display area in prior art is eliminated.

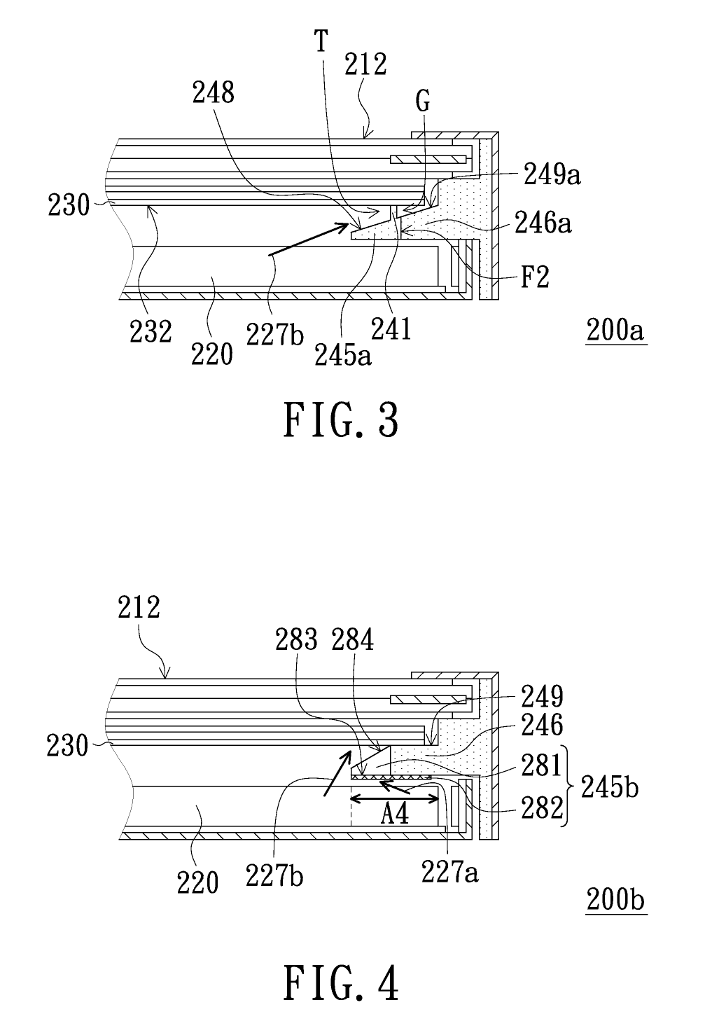

FIG. 3 is a schematic partial cross-sectional view of a display apparatus in accordance with another embodiment of the present disclosure. As shown in FIG. 3, the structure of the display apparatus 200a is similar to that of the display apparatus 200 in FIG. 2 and thus the display apparatus 200a is also benefited by this specific structure, so hereinafter only the structural differences therebetween will be described in detail. In the present embodiment, a plurality of supporting pillars 241 (only one supporting pillar 241 is exemplified in FIG. 3) are formed on the first surface 248 of the light shielding part 245a facing to the optical film 230. These supporting pillars 241 are formed in a row manner to support the optical film 230 and spaced from each other. The first support part 246a has a second surface 249a facing to the optical film 230, and the first surface 248 of the light shielding part 245a and the second surface 249a of the first support part 246a each are a inclined plane relative to the light incident surface 232 of the optical film 230. According to the above-described structure, the light-pervious area T is formed between the light incident surface 232 and the first surface 248 and a gap G is formed between the light incident surface 232 and the second surface 249a. In other words, compared with FIG. 2, the additional gap G is formed between the second surface 249a and the optical film 230. Therefore, the fully mixed light 227b enters into the specific area of the optical film 230 corresponding to the light shielding part 245 through the light-pervious area T and into the specific area of the optical film 230 corresponding to the second surface 249a through the gap G as well as the gaps between the supporting pillars 241. And thus, the dark region in the edge area of the display area 212 is further eliminated.

In another embodiment, except the supporting pillars 241, the optical film 230 still can be directly supported by the second surface 249a through disposing a sidewall of the optical film 230 on the second surface 249a even if the gap is formed between the second surface 249a and the optical film 230. In addition, the first and second surfaces 248, 249a each are not limited to a inclined plane; in other words, the first and second surfaces 248, 249a each can have other specific structures as long as capable of forming gaps between the first or second surface 248 or 249a and the optical film 230. In addition, because the contacting areas between the optical film 230 and the supporting pillars 241 may result in dark spots, in the embodiment, one end of each supporting pillar 241 contacting to the optical film 230 can be designed to have a cusp-like structure or an arc-like structure, and accordingly the contacting areas between the optical film 230 and the supporting pillars 241 are reduced so as to eliminate the dark spots. In another embodiment, the supporting pillars 241 can be made of a light-pervious material to further eliminate the dark spots.

FIG. 4 is a schematic partial cross-sectional view of a display apparatus in accordance with another embodiment of the present disclosure. As shown in FIG. 4, the structure of the display apparatus 200b is similar to that of the display apparatus 200b in FIG. 2 and thus the display apparatus 200b is also benefited by this specific structure, so hereinafter only the structural differences therebetween will be described in detail. In the present embodiment, the light shielding part 245b includes a light-pervious block 281 made of a light-pervious material and a film layer 282 made of an opaque material. The film layer 282 is disposed on a bottom surface 283 of the light-pervious block 281 facing to the light guide plate 220 and is configured to block the non fully mixed light 227a emitting the area A4 of the light guide plate 220. The film layer 282 is, for example, a reflective layer. Still, a gap is formed between the optical film 230 and a surface 284 of the light-pervious block 281 facing to the optical film 230, and thus an air layer is formed between the surface 284 and the optical film 230. The surface 284 is, for example, an inclined plane relative to the supporting plane 249 of the first support part 246; however, the structure of the surface 284 is not limited as such, and the first surface 248 may, for example, have other structures such as a curved plane.

In the present embodiment as shown in FIG. 4, the fully mixed light 227b can be transmitted through the light-pervious block 281. Therefore, the air layer, formed between the surface 284 and the optical film 230, and the light-pervious block 281 cooperatively function as a light-pervious area, and thus the dark region in the edge area of the display area 212 can be eliminated more efficiently. Based on the same manner, it is to be noted that the light shielding part 245a in FIG. 3 can also be a light-pervious block by being made of a light-pervious material, and the film layer 283 as shown in FIG. 4 can be disposed on a surface of the light shielding part 245a facing to the light guide plate 220.

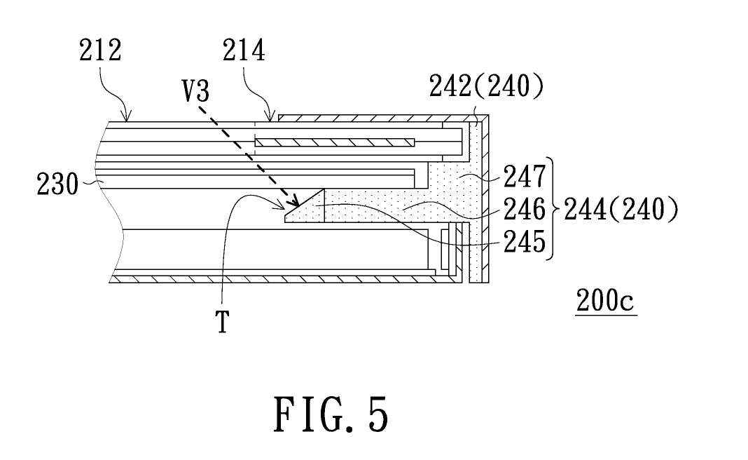

FIG. 5 is a schematic partial cross-sectional view of a display apparatus in accordance with another embodiment of the present disclosure. As shown in FIG. 5, the display apparatus 200c is different with the display apparatus 200 in that the entire light shielding part 245 of the support structure 244 is under cover of the non-display area 214; in other words, no any part of the light shielding part 245 is under cover of the display area 212.

In the present embodiment as shown in FIG. 5, because the light-pervious area T is formed between the light shielding part 245 and the optical film 230, a user will not see the dark region in an edge area of the display area 212 even the user has a viewing direction V3. In addition, it is to be noted that the light shielding part 245 in the present embodiment can be replaced by the light shielding part 245a in FIG. 3 or the light shielding part 245b in FIG. 4, and the first support part 246 in the present embodiment can be replaced by the first support part 246a in FIG. 3.

To sum up, in the display apparatus according to the present disclosure, because the light-pervious area is formed between the light shielding part and the optical film(s) and the light can enter into a specific area of the optical film corresponding to the light shielding part through the light-pervious area. Thus, the display apparatus of the present disclosure can have enhanced brightness in the edge area of the display area thereof. Accordingly, the display apparatus of the present disclosure can have the narrow boarder but without resulting in dark regions in the edge area of the display area thereof.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display apparatus, comprising:
a display panel defined to have a display area and a non-display area adjacent to the display area;
a light guide plate;
an optical film disposed between the display panel and the light guide plate; and
a frame configured to surround the light guide plate, the optical film and the display panel and comprising a sidewall and a support structure, wherein the support structure extends from an inner surface of the sidewall to above the light guide plate, the support structure comprises a light shielding part and a first support part configured to support the optical film, the light shielding part is connected to the first support part, a light-pervious area is formed between the light shielding part and the optical film, and the first support part is under cover of the non-display area.

2. The display apparatus according to claim 1, wherein a boundary between the first support part and the light shielding part is under cover of the non-display area.

3. The display apparatus according to claim 1, wherein the light shielding part is made of an opaque material, and the light-pervious area comprises an air layer formed between the optical film and a first surface of the light shielding part facing to the optical film.

4. The display apparatus according to claim 3, wherein the first support part comprises a supporting plane configured to support the optical film, and the first surface of the light shielding part is an inclined plane relative to the supporting plane.

5. The display apparatus according to claim 3, wherein the light shielding part comprises a first surface facing to the optical film and a plurality of supporting pillars formed on the first surface, and the supporting pillars are configured to support the optical film.

6. The display apparatus according to claim 5, wherein one end of each supporting pillar contacting to the optical film has a cusp-like structure or an arc-like structure.

7. The display apparatus according to claim 5, wherein the first support part comprises a second surface facing to the optical film, and each of the first and second surfaces is an inclined plane relative to a light incident surface of the optical film.

8. The display apparatus according to claim 1, wherein the light shielding part comprises a first surface facing to the optical film and a plurality of supporting pillars formed on the first surface, and the supporting pillars support the optical film.

9. The display apparatus according to claim 1, wherein the light shielding part comprises a light-pervious block made of a light-pervious material and a film layer made of an opaque material, and the film layer is disposed on a bottom surface of the light-pervious block facing to the light guide plate.

10. The display apparatus according to claim 9, wherein the light-pervious area comprises the light-pervious block and an air layer, the air layer is formed between the optical film and a surface of the light-pervious block facing to the optical film.

11. The display apparatus according to claim 9, wherein the film layer is a reflective layer.

12. The display apparatus according to claim 9, wherein the first support part comprises a supporting plane configured to support the optical film, and a surface of the light-pervious block facing to the optical film is an inclined plane relative to the supporting plane.

13. The display apparatus according to claim 1, wherein the light guide plate comprises a light incident surface and a light emitting surface, the light emitting surface is opposite to the optical film, and the display apparatus further comprises a light emitting assembly disposed next to the light incident surface.

14. The display apparatus according to claim 1, wherein at least a portion of the light shielding part is under cover of the display area.

15. The display apparatus according to claim 1, wherein the entire light shielding part is under cover of the non-display area.

16. The display apparatus according to claim 1, wherein the support structure further comprises a second support part configured to support the display panel.

17. The display apparatus according to claim 1, wherein the support structure has a stair-like shape.
